(19) United States
(12) Patent Application Publication
(10) Pub. No.: US 2009/0184814 A1
(43) Pub. Date: Jul. 23, 2009

(54) Wireless tire pressure monitoring system with interactive multiple frequency channel

(76) Inventors: Hui-Chang Lee, Taipei (TW); Kamwa Chen, Taipei (TW); Chien-Lung Lin, Taipei (TW); Liang-Chuan Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/010,001

(22) Filed: Jan. 18, 2008

(51) Int. Cl. B60C 23/00

(52) U.S. Cl. 340/447

(57) ABSTRACT

A wireless tire pressure monitoring system with interactive multiple frequency channel includes a controlling host module and multiple tire detection units. The controlling host module includes a first CPU, a key unit, a display unit, a low-frequency wireless transmitter, and a high-frequency wireless receiver. The tire detection units are separately provided on tires of a vehicle and each include a second CPU, a tire information detecting device, a low-frequency wireless receiver, and a high-frequency wireless transmitter. A default standard value may be set via the key unit. The low-frequency wireless transmitter transmits a low-frequency signal to each of the low-frequency wireless receivers for requesting the tire detection units to transmit current tire information, which is then sent via a high-frequency signal transmitted by the high-frequency wireless transmitter to the high-frequency wireless receiver.

### FIELD OF THE INVENTION

The present invention relates to a tire pressure monitoring system, and more particularly to a wireless tire pressure monitoring system with interactive multiple frequency channel.

### BACKGROUND OF THE INVENTION

Various types of cars have become prerequisite traffic means or transporting equipment for people living in the modern society. As a result, people pay more and more attention to the safety in driving a car. For example, tire pressure detection is very important for a car. If the tire pressure is 80% lower than the normally required tire pressure over a long period of time, the tire tends to have a dramatic temperature rise that results in a blowout when the car is moving at a high speed. Indoor tests prove that when the tire pressure is 25% higher than a standard tire pressure value, the usable life of tire shortens by 15˜20%; and when the tire pressure is 25% lower than the standard value, the usable life of tire shortens by 30%. Properly inflated tire not only has enhanced performance and safety in use, but also saves more fuel and has prolonged tire life. However, according to statistics, 20% of the currently being used cars have insufficiently inflated tires. Moreover, tire temperature also has important influence on the safe driving. The higher the tire temperature is, the lower the tire strength is. That is, tire with high tire temperature is more easily deformed. And, the tire wearing increases by 2% when the tire temperature rises by 1° C.

To ensure safe driving, various kinds of tire pressure monitoring systems have been developed. Taiwan Utility Model Publication No. 535741 discloses an automobile tire pressure and tire temperature sensing device, which includes a pressure and temperature sensor fixed to an inner side of a tire to be enclosed in the tire; and a ferrite-core transmission antenna fixedly mounted to a suspension support located directly above the tire. The ferrite-core antenna is electrically connected to a main transceiver in the car. The main transceiver periodically causes the ferrite-core antenna to transmit an electric energy signal to the tire. The electric energy signal is received by an antenna of the pressure and temperature sensing device mounted in the tire and is stored in a capacitor as a power supply to the circuits in the pressure and temperature sensing device, so that the pressure and temperature sensing device may send information about the tire pressure and temperature of the car to the main transceiver by way of high-frequency wireless transmission without the need of any battery. The main transceiver in the car will display the received tire pressure and temperature. In the event the tire pressure or the tire temperature exceed respective standard values, the main transceiver will emit a warning sound to warn the driver, so as to avoid any tire blowout on the way of driving.

Taiwan Utility Model Publication No. 436433 discloses an annular device being embedded in a toroidal region of an inflated tire or attached to an elastic ring on a rim. The annular device is coaxially positioned on the tire or the wheel, and is preferably embedded in the tire at an equatorial plane (EP) thereof. The annular device includes a radio frequency transponder internally having an integrated circuit (IC) chip and a selective sensor in the chip or associated with the chip. The IC chip of the transponder has a capacity sufficient for sending at least identification data about the tire or the wheel. The antenna thereof includes an electrically conductive body and a rubber-matrix compound. Wherein, the rubber-matrix compound is substantially extendable.

Taiwan Utility Model Publication No. I224561 discloses a tire detection system with wireless setting function, which includes a wireless setting device and a plural set of tire pressure detecting devices. The wireless setting device mainly includes a signal processor and at least one set of low-frequency signal transceiver. The signal processor is built therein a plural set of position codes in the number corresponding to that of tires, so as to process a setting signal and send the same to the low-frequency signal transceiver. The setting signal includes a reset signal and a set of position encoding data. Each set of the tire pressure detecting devices mainly includes a detecting and signal processing unit, a low-frequency signal transceiver, a reset switch, and a radio-frequency (RF) transmitter. The detecting and signal processing unit is provided with a reset end, which is connected to the low-frequency signal transceiver via the reset switch.

Taiwan Utility Model Publication No. 534007 discloses a telemetric and remote displaying tire pressure detecting and warning system, which includes a tire pressure sensing unit provided on each tire of a car, a monitoring unit directly or indirectly electrically connected to a car power supply system, and a remote control and display unit carried by a user. By wireless transmitting and receiving as well as remote controlling techniques, tire pressure measured by the tire pressure sensing unit is sent to the remote control and display unit held by the user directly or indirectly via the monitoring unit, so that tire pressure may be remotely measured without the need of getting on the car or starting the car power supply system.

The signals transmitted by the wireless transmitters of prior art tire pressure monitoring systems all are single-frequency signals. That is, the wireless transmitters of the prior art tire pressure monitoring systems transmit wireless signals at one single frequency. Therefore, when two cars having the same type of tire pressure monitoring system mounted thereon get closer to each other, wireless signal interference will occur between the two cars. Moreover, the tire pressure sensing device mounted on each tire must be assigned a unique identification code for a monitoring end of the tire pressure monitoring system to identify the tire information returned from different tires.

It is also noted the conventional tire pressure monitoring systems do not allow a user to set a standard pressure value according to different types of car or to set a safety tire pressure value according to different road conditions. Therefore, the conventional tire pressure monitoring systems have a narrow range of applications and have the problem of signal interference.

### SUMMARY OF THE INVENTION

A primary object of the present invention is to provide a wireless tire pressure monitoring system with interactive multiple frequency channel, so as to reduce wireless signal interference by and between nearby vehicles, and to enable recognition of tire pressure of different tires without the need of providing an identification code to each tire.

Another object of the present invention is to provide a tire pressure monitoring system that allows a user to set different standard values for a tire, so that a user may adjust the settings according to the road condition and the type of car.

To fulfill the above objects, the present invention provides a wireless tire pressure monitoring system with interactive multiple frequency channel includes a controlling host module and multiple tire detection units. The controlling host module includes a first CPU, a key unit, a display unit, a low-frequency wireless transmitter, and a high-frequency wireless receiver. The tire detection units are separately provided on tires of a vehicle and each include a second CPU, a tire information detecting device, a low-frequency wireless receiver, and a high-frequency wireless transmitter. A default standard value may be set via the key unit. The low-frequency wireless transmitter transmits a low-frequency signal to each of the low-frequency wireless receivers for requesting the tire detection units to transmit current tire information, which is then sent via a high-frequency signal transmitted by the high-frequency wireless transmitter to the high-frequency wireless receiver. The first CPU will compare the tire information with the default standard values. In the event the tire pressure value detected is lower than the default low pressure value, the CPU will generate a tire pressure warning signal to a tire pressure warning unit for the same to send out a warning.

The low-frequency signals transmitted from the low-frequency wireless transmitter of the controlling host module to the tire detection units have a different frequency each, and the high-frequency signals transmitted from the high-frequency wireless transmitter of the tire detection units to the controlling host module have a different frequency each.

With the technical means adopted by the present invention, the wireless signal interference by nearby vehicles may be reduced, and it is not necessary to provide each tire on the vehicle with a unique identification code for recognizing the tire information for each different tire. Moreover, a user may set different standard values for tire according to road condition and car type.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 shows an arrangement of a wireless tire pressure monitoring system of the present invention on a transport vehicle;

FIG. 2 shows how the wireless tire pressure monitoring system of the present invention operates;

FIG. 3 shows a control circuit diagram of a wireless tire pressure monitoring system according to a first embodiment of the present invention; and

FIG. 4 shows a control circuit diagram of a wireless tire pressure monitoring system according to a second embodiment of the present invention.

### DETAILED DESCRIPTION OF THE PREFERRED EMBODIMENTS

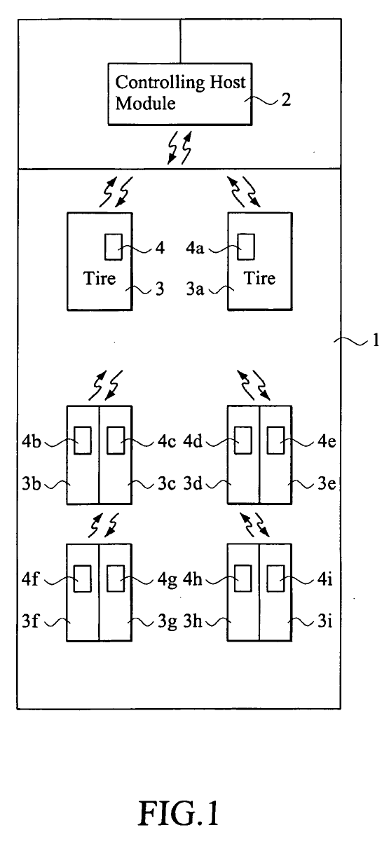

Please refer to FIG. 1, which shows an arrangement of a wireless tire pressure monitoring system. The present invention provides a wireless tire pressure monitoring system with interactive multiple frequency channel for using on a transport vehicle 1, which may be a truck, a station wagon, a sedan, or the like. The wireless tire pressure monitoring system with interactive multiple frequency channel according to a first embodiment of the present invention includes a controlling host module 2 and a plurality of tire detection units 4, 4a-4i. The controlling host module 2 may be positioned in the vicinity of a driver seat or be carried by a driver for tire monitoring from time to time. The tire detection units 4, 4a-4i are separately arranged in the tires 3, 3a-3i of the transport vehicle 1.

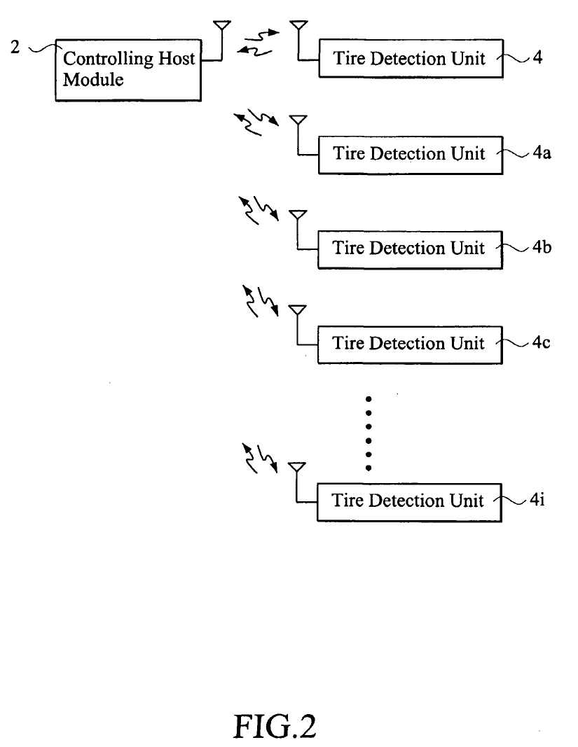

FIG. 2 shows how the wireless tire pressure monitoring system of the present invention operates. As it can be seen from FIG. 2, the controlling host module 2 is able to transmit a low-frequency signal to each of the tire detection units 4, 4a-4i for the same to return the current tire information. On receipt of the low-frequency signal transmitted from the controlling host module 2, the tire detection units 4, 4a-4i will respectively return the current tire information in the form of a high-frequency signal to the controlling host module 2. By sending signals to and from the controlling host module 2 in two different frequencies, signal interference by and between nearby vehicles may be reduced.

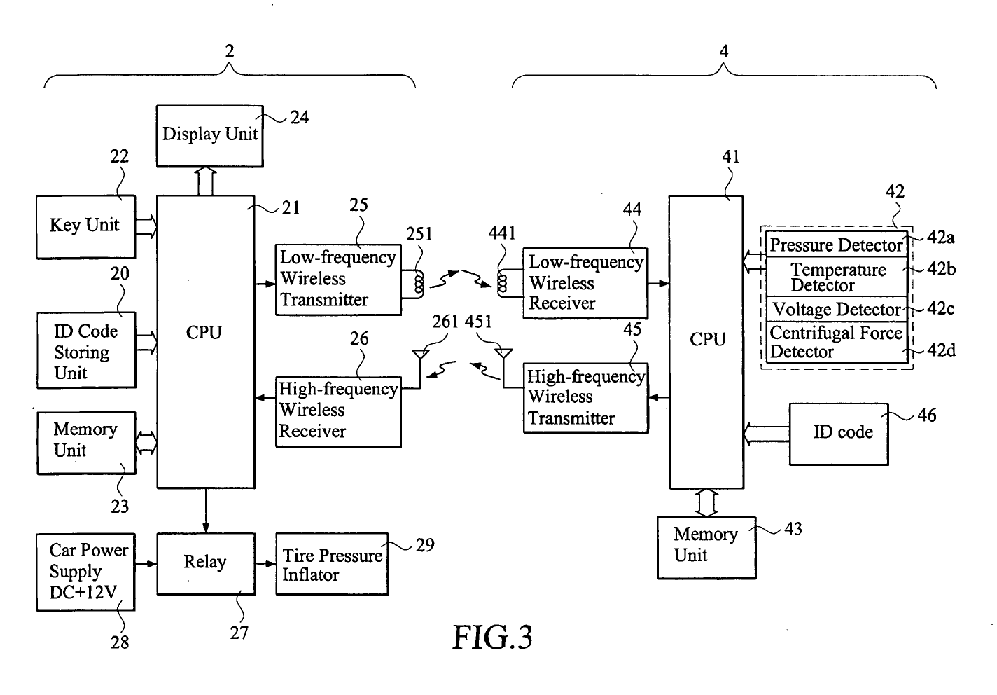

FIG. 3 shows the control circuits of the controlling host module 2 and the tire detection unit 4 according to a first embodiment of the present invention. All other tire detection units 4a to 4i have the same control circuit as that of the tire detection unit 4. In the first embodiment of the present invention, the low-frequency signal is transmitted from the controlling host module 2 to the tire detection units 4, 4a-4i at the same time. Alternatively, the low-frequency signals are sequentially transmitted from the controlling host module 2 to the tire detection units 4, 4a-4i one by one.

The controlling host module 2 includes an identification code storing unit 20, a central processing unit (CPU) 21, a key unit 22, a memory unit 23, a display unit 24, a low-frequency wireless transmitter 25, a high-frequency wireless receiver 26, and a relay 27. The identification code storing unit 20, the key unit 22, the memory unit 23, the display unit 24, the low-frequency wireless transmitter 25, the high-frequency wireless receiver 26, and the relay 27 are separately electrically connected to the CPU 21; and the relay 27 is electrically connected to a car power supply 28 and a tire pressure inflator 29. The low-frequency wireless transmitter 25 includes a coil 251, and the high-frequency wireless receiver 26 includes an antenna 261.

The tire detection unit 4 includes a CPU 41, a tire information detecting device 42, a memory unit 43, a low-frequency wireless receiver 44, a high-frequency wireless transmitter 45, and an identification code 46. The tire information detecting device 42 includes a pressure detector 42a, a temperature detector 42b, a voltage detector 42c, and a centrifugal force detector 42d. The tire information detecting device 42, the memory unit 43, the low-frequency wireless receiver 44, the high-frequency wireless transmitter 45, and the identification code 46 are separately electrically connected to the CPU 41. The low-frequency wireless receiver 44 includes a coil 441, and the high-frequency wireless transmitter 45 includes an antenna 451.

The identification code storing unit 20 has the identification codes of the tire detection units 4, 4a-4i stored thereon. Via the CPU 21, a default standard value, such as a standard pressure value, a standard temperature value, a standard voltage value, a standard centrifugal force value, etc., may be set via the key unit 22 and displayed at the display unit 24. The default standard value is stored on the memory unit 23 by the CPU 21. Different default standard values may be set at the key unit 22 according to the type of vehicle and the road condition. Different types of tire information, such as tire pressure, tire temperature, voltage, centrifugal force, etc., may be displayed at the display unit 24. And, the display unit 24 may be switched among different tire information by operating at the key unit 22.

Moreover, a signal may be transmitted via the key unit 22 for the CPU 21 to generate an enable signal or a disable signal to the low-frequency wireless transmitter 25 for starting or stopping the detection of tire pressure, tire temperature, voltage, centrifugal force, etc. The enable/disable signal is then sent via a low-frequency signal transmitted from the low-frequency wireless transmitter 25 to the low-frequency wireless receiver 44 of the tire detection unit 4. In the case the signal received by the low-frequency wireless receiver 44 is an enable signal, and the received enable signal is then sent to the CPU 41, the CPU 41 will start receiving tire information, such as tire pressure, tire temperature, voltage, centrifugal force, etc., detected by the tire information detecting device 42.

The CPU 41 also stores the tire information detected by the tire information detecting device 42 on the memory unit 43, and sends the detected tire information and the identification code 46 to the high-frequency wireless receiver 26 via a high-frequency signal transmitted by the high-frequency wireless transmitter 45. The high-frequency signal is transmitted at intervals of one second. The high-frequency wireless receiver 26 receives the tire information and the identification code 46 of the tire detection unit 4 and further sends the information to the CPU 21, at where the identification code 46 of the tire detection unit 4 is compared with the identification codes stored on the identification code storing unit 20, so as to verify from which one of the tire detection units the received tire information comes from.

The CPU 21 will compare the received tire information with the default standard values preset via the key unit 22. In the event the received tire information does not fall within a range of the preset default standard values, such as a tire pressure value detected by the tire pressure detector 42a is lower than the default low pressure value preset via the key unit 22, the CPU 21 will generate a tire inflating signal to control and actuate the relay 27, so that the car power supply 28 is connected to the tire pressure inflator 29, and a user may inflate the tire 3 corresponding to the tire detection unit 4 using the tire pressure inflator 29. When the tire pressure of the tire 3 has reached the default pressure value preset via the key unit 22, the CPU 21 generates a cut-off signal to the relay 27 to cut off the car power supply and stop inflating the tire 3.

In the event a signal is sent via the key unit 22 to the CPU 21 for the same to generate a disable signal to the low-frequency wireless transmitter 25, the low-frequency wireless transmitter 25 will send the received disable signal to the low-frequency wireless receiver 44 of the tire detection unit 4. The disable signal sent to the tire detection unit 4 is then sent by the CPU 41 to the tire information detecting device 42, driving the latter to stop detecting tire information. Alternatively, the tire information detecting device 42 is driven to stop detecting the tire information after the tire information detection has been continued for three minutes since the receipt of the enable signal.

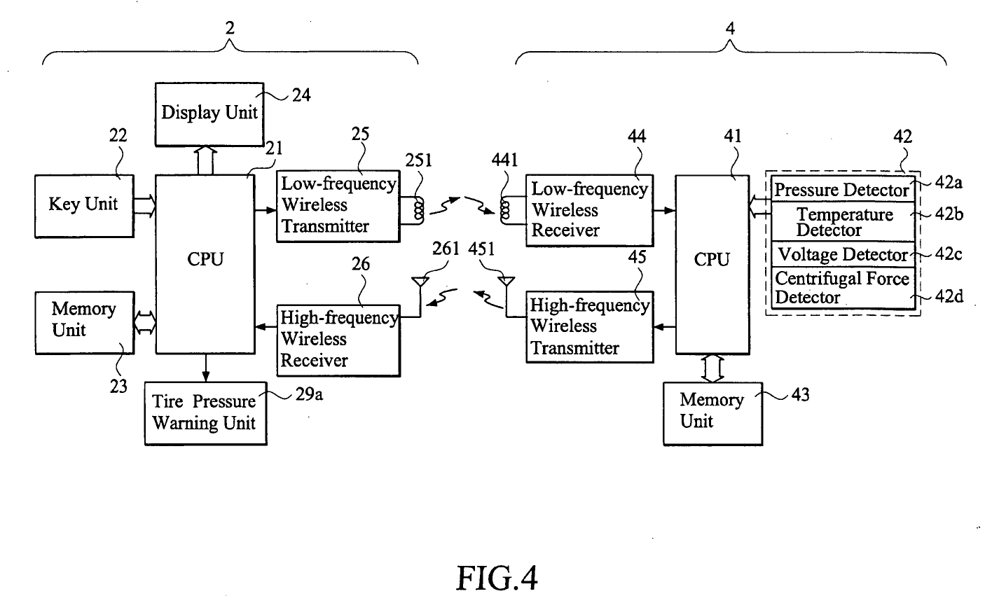

FIG. 4 is a control circuit diagram of a wireless tire pressure monitoring system with interactive multiple frequency channel according to a second embodiment of the present invention. Since the circuitry of the second embodiment is generally similar to that of the first embodiment, parts that are the same in the two embodiments are denoted by the same reference numerals.

The circuitry of the second embodiment is different from that of the first embodiment in that the identification code storing unit 20 is omitted from the controlling host module 2, and the identification code 46 is omitted from the tire detection units 4, 4a-4i. In the second embodiment, the controlling host module 2 scans constantly and sequentially sends low-frequency signals to the tire detection units 4, 4a-4i one by one. The low-frequency signals sent to the tire detection units 4, 4a-4i by the controlling host module 2 have a different low frequency each, and the high-frequency signals returned to the controlling host module 2 by the tire detection units 4, 4a-4i also have a different high frequency each. In this manner, the CPU 21 of the controlling host module 2 is able to determine from which tire detection unit the received tire information comes from, and the signal interference caused by nearby vehicles may be reduced.

For example, the controlling host module 2 may send via the CPU 21 and the low-frequency wireless transmitter 25 a first low-frequency signal of 125 KHz to the tire detection unit 4, and a second low-frequency signal of 130 KHz to the tire detection unit 4a five seconds later, and a third low-frequency signal of 135 KHz to the tire detection unit 4b another five seconds later, etc. And, the tire detection unit 4 returns via the CPU 41 and the high-frequency wireless transmitter 45 a high-frequency signal of 315 KHz to the controlling host module 2, the tire detection unit 4a returns a high-frequency signal of 320 KHz to the controlling host module 2, the tire detection unit 4b returns a high-frequency signal of 325 KHz to the controlling host module 2, etc.

When the CPU 21 compares the received tire information with the default standard value preset via the key unit 22, and it is found the received tire information does not fall within a range of the default standard values preset via the key unit 22, such as the tire pressure detected by the pressure detector 42a is lower than the default low pressure value preset via the key unit 22, the CPU 21 will generate a tire pressure warning signal to a tire pressure warning unit 29a for the same to send out a warning, so that the user is reminded to inflate the tire 3, on which the tire detection unit 4 is provided.

Preferably, when the transport vehicle 1 is moving, the tire detection unit 4 returns the tire information via the CPU 41 and the high-frequency signal of the high-frequency wireless transmitter 45 to the controlling host module 2 at intervals of five minutes. And, the controlling host module 2 preferably includes a preset default tire pressure warning value. For example, a standard tire pressure value and a standard tire temperature value are set via the key unit 22. The controlling host module 2 will emit a safety warning when the tire pressure drops by 15% compared to the preset standard tire pressure value, and a danger warning when the tire pressure drops by 30% compared to the preset standard tire pressure value; the controlling host module 2 will also emit a safety warning when the tire temperature reaches 80° C., and a danger warning when the tire temperature reaches 95° C.

While the present invention has been described with reference to the specific embodiments, the description is illustrative of the invention and is not to be construed as limiting the invention. Therefore, various modifications to the present invention can be made to the preferred embodiments by those skilled in the art without departing from the true spirit and scope of the invention as defined by the appended claims.

What is claimed is:

1. A wireless tire pressure monitoring system, comprising a controlling host module and a plurality of tire detection units;
the controlling host module including:
a first central processing unit (CPU);
a key unit electrically connected to the first CPU for setting a default standard value;
a display unit electrically connected to the first CPU;
a low-frequency wireless transmitter electrically connected to the first CPU for transmitting a low-frequency signal to the tire detection units and thereby informing the tire detection units to return current tire information; and
a high-frequency wireless receiver electrically connected to the first CPU for receiving the tire information returned by the tire detection units and sending the received tire information to the first CPU; and
the tire detection units being separately provided on tires of a transport vehicle, and each including:
a second CPU;
a tire information detecting device electrically connected to the second CPU for detecting tire information;
a low-frequency wireless receiver electrically connected to the second CPU for receiving the low-frequency signal transmitted from the low-frequency wireless transmitter of the controlling host module; and
a high-frequency wireless transmitter electrically connected to the second CPU for transmitting a high-frequency signal to transmit the tire information detected by the tire information detecting device to the high-frequency wireless receiver of the controlling host module.

2. The wireless tire pressure monitoring system as claimed in claim 1, wherein the controlling host module further includes a memory unit electrically connected to the first CPU for storing the default standard value set via the key unit.

3. The wireless tire pressure monitoring system as claimed in claim 1, wherein the tire information detecting device is a pressure detector for detecting a tire pressure of a tire.

4. The wireless tire pressure monitoring system as claimed in claim 3, wherein the controlling host module further includes a relay electrically connected to the first CPU for connecting a car power supply to a tire pressure inflator; whereby when the first CPU of the controlling host module compares the received tire information with the default standard value set via the key unit and, if a current tire pressure value that is lower than the default standard value is detected, the first CPU generates a tire inflating signal to control and actuate the relay for the same to connect the car power supply to the tire pressure inflator.

5. The wireless tire pressure monitoring system as claimed in claim 3, wherein the controlling host module further includes a tire pressure warning unit electrically connected to the first CPU; whereby when the first CPU of the controlling host module compares the received tire information with the default standard value set via the key unit and, if a current tire pressure value that is lower than the default standard value is detected, the first CPU generates a tire warning signal to the tire pressure warning unit for the same to emit a warning.

6. The wireless tire pressure monitoring system as claimed in claim 1, wherein each of the tire detection units further includes a memory unit electrically connected to the second CPU for storing the tire information detected by the tire information detecting device thereof.

7. The wireless tire pressure monitoring system as claimed in claim 1, wherein the tire detection unit is a temperature detector.

8. The wireless tire pressure monitoring system as claimed in claim 1, wherein the tire detection unit is a voltage detector.

9. The wireless tire pressure monitoring system as claimed in claim 1, wherein the tire detection unit is a centrifugal force detector.

10. The wireless tire pressure monitoring system as claimed in claim 1, wherein each of the tire detection units includes an identification code electrically connected to the second CPU, and the high-frequency wireless transmitter transmits both the tire information detected by the tire information detecting device and the identification code of the tire detection unit to the high-frequency wireless receiver of the controlling host module; and the high-frequency wireless receiver of the controlling host module sends the received tire information detected by the tire information detecting device and the received identification code of the tire detection unit to the first CPU.

11. The wireless tire pressure monitoring system as claimed in claim 10, wherein the controlling host module includes an identification code storing unit electrically connected to the first CPU for storing the identification codes of the plurality of tire detection units; whereby when the first CPU receives the tire information detected by the tire information detecting device and the identification code of the tire detection unit, the first CPU compares the received identification code with the identification codes of the tire detection units stored on the identification code storing unit to determine from which one of the tire detection units the tire information comes from.

12. The wireless tire pressure monitoring system as claimed in claim 1, wherein the low-frequency signals transmitted from the low-frequency wireless transmitter of the controlling host module to the tire detection units have a different frequency each.

13. The wireless tire pressure monitoring system as claimed in claim 1, wherein the high-frequency signals transmitted from the high-frequency wireless transmitter of the tire detection units to the controlling host module have a different frequency each.
